(19) United States
(12) Patent Application Publication
(10) Pub. No.: US 2008/0177617 A1
(43) Pub. Date: Jul. 24, 2008

(54) Content production/sharing platform

(76) Inventor: Amit Gupta, Austin, TX (US)

Correspondence Address: Amit Gupta, 49 Rick Lane, Cortlandt Manor, NY, 10567, US

(21) Appl. No.: 12/011,098

(22) Filed: Jan. 24, 2008

Related U.S. Application Data
(60) Provisional application No. 60/897,196, filed on Jan. 24, 2007.

(51) Int. Cl. G06F 17/00

(52) U.S. Cl. 705/10

(57) ABSTRACT

Systems and methods provide a computer-implemented interactive system and methods allowing the interactive production and/or sharing of content. In an illustrative implementation, a computing environment comprises a content production/content engine having at least one instruction providing for the production and/or sharing of content according to one or more elected content production/sharing paradigms. In the illustrative implementation, the content production/sharing paradigm can comprise content production guidelines that provide threshold requirements including community feedback for use to assist participating users in producing content. Further, in the illustrative implementation, the content production/sharing paradigm can comprise a content distribution/sharing model operating to distribute revenue of the sale/purchase of content according using multi-level commission principles. In an illustrative operation, participating users, community members, and/or producers can interact with the computing environment for the purchase, sale, production, and production financing of content (e.g., according to one or more selected content financing production schemes).

### CLAIM OF PRIORITY

This application claims the benefit of and priority to U.S. Provisional Patent Application Ser. No. 60/897,196 filed on Jan. 24, 2007, entitled, “CONTENT PRODUCTION/SHARING PLATFORM,” the contents of which are incorporated herein in their entirety.

### BACKGROUND

The business of producing, distributing and exploiting entertainment productions, e.g., motion pictures, television and cable programming, music, videos, video games and digital entertainment programming (“content”) is subject to a high degree of risk. This is because the cost structure for producing content is high and heavily front end-loaded, whereas the revenue structure for the distribution and other exploitation of content is back-end loaded and speculative (since it is highly dependent on public tastes and attitudes which are unpredictable and which are subject to sudden change for a variety of reasons, including the availability of other competing content and other types of entertainment).

The production, distribution and exploitation of content generally requires the commitment of multimillion dollar expenditures based largely on a preproduction subjective evaluation of the commercial potential of a proposed project (typically determined years before the completion and distribution of the project). These production costs, as well as the costs of marketing and distributing content, have increased significantly in recent years and at a rate faster than the general rate of increase in revenues generated from the distribution and other exploitation of content. This is because of a multiplicity of factors beyond the control of producers of content, including ever-increasing compensation demands of creative and artistic talent, scarcity of commercially viable intellectual properties, intense-competition among producers and distributors of all forms of entertainment products, the increasing number of entertainment products, and the increasing diversity of different types of entertainment, all vying for the leisure time spending of the consuming public.

As a result of these and other fluctuating, unpredictable and subjective factors, a significant percentage of content annually produced and distributed by major entertainment companies (as well as smaller independent production companies) are unprofitable after taking into account the relevant production costs, distribution fees, distribution, marketing and promotional expenses, contingent compensation payable to creative and artistic talent, amounts payable under applicable union agreements and interest expenses.

There are presently several-problems related to the production of content, including high production costs, high investment risk, and a high instance of financial failure. Revenues generated from the content's distribution are often much less than the cost of production. The high cost of producing and distributing content continues to escalate each year. These ever increasing costs create a commensurate increase in risk for movie investors. A significant percentage of box office failures is largely due to the inability of movie producers and/or record producers to accurately predict the number of tickets or albums/songs that will be purchased. Although various market surveys are presently performed by these content producing industries, content producers have been unable to use these methods to determine what the exact size of the audience for specific content will be, and consequently cannot determine whether the sale of such content (e.g., through movie ticket, DVD, CD, online music subscription sales) sold will pay for the cost of production of the content.

Furthermore, even in cases where particular content turn out to be profitable on paper, content producers and content investors are often unable to collect their profit share from the distributors of their content. Distributors of content (e.g., feature films) often use “creative accounting” methods for reporting the profits on sales of content. Furthermore, the content producers and content investors have little or no control over expenses charged against the content by the distributors. In many instances, the content's distributor makes a considerable profit, but after the distributor's “expenses” are deducted, the content producers and investors do not.

Another significant problem for all content producers is “creative meddling” by a studio, record label, or distributor. Generally, in order to secure financing for the production of their content (e.g., film, music, digital works, works of art), content producers are often forced to accept choices for creative elements in the content to be produced that prove to be undesirable to the audience and/or future purchaser. For example, a studio, label, or gallery may require a content producer to use a certain element in the film (e.g., use of a particular actor in a film), because that element is a reusable resource to the studio, label, and/or gallery (e.g., the star is under contract to the studio or that star can get them greater foreign sales guarantees), and not because that element would best serve the content to be produced. Significant creative choices in producing content are often made arbitrarily, by a single individual, without input from the potential audience and/or other content producers. To date, there has never been an accurate method for determining if these creative choices content production that are those most desired by the audience, community, and/or purchasers.

Additionally, with current distribution/sharing schemes, the revenue generated by the sale/purchase of produced content is generally collected by a handful of parties (e.g., studio, label, gallery, distributor, movie theater, etc.) without providing an opportunity for the general public (e.g., online networked community) to share in the revenue through resale or further distribution of the produced content. Having such restricted distribution/sharing schemes ultimately provides less revenue potential to the content producer as the audience has less incentive to engage in viral marketing (and sale) of the produced content.

From the foregoing, it is appreciated that there exists a need for systems and methods that are aimed to ameliorate the shortcomings of existing practices.

### SUMMARY

Systems and methods provide a computer-implemented interactive system and methods allowing the interactive production and/or sharing of content. In an illustrative implementation, a computing environment comprises a content production/content engine having at least one instruction providing for the production and/or sharing of content according to one or more elected content production/sharing paradigms. In the illustrative implementation, the content production/sharing paradigm can comprise content production guidelines that provide threshold requirements including community feedback for use to assist participating users in producing content. Further, in the illustrative implementation, the content production/sharing paradigm can comprise a content distribution/sharing model operating to distribute revenue of the sale/purchase of content according using multi-level commission principles.

In an illustrative operation, participating users, community members, and/or producers can interact with the computing environment for the purchase, sale, production, and production financing of content. In the illustrative operation, when engaging in the sale of content, content producers (and/or owners) can aggregate content to establish channels of content which community users can reference as a source of similarly produced, owned, or similar subject-matter content. In the illustrative operation, when engaging in the purchase of content, one or more portions of completed content can be purchased for use in subsequent production of other content. In the illustrative operation, when engaging in producing content, a container having one or more proposal sections (e.g., content idea, script/score, budget, and/or demo) is generated by a participating user and offered a rating by one or more community members as a measure of possible commercial success of the content to be produced. Using a selected threshold requirement including the community rating, the suggested content to be produced can be released to the community and/or cooperating producers to produce the content. Further in the illustrative operation, the approved container can be released to the community as part of production fmancing efforts according to one or more selected content fmancing production schemes (e.g., securitization of content to be produced to raise funds to produce content).

Other features of the herein described systems and methods are further described below.

### BRIEF DESCRIPTION OF THE DRAWINGS

The interactive systems and methods for interactive content production/distribution described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a block diagram showing the cooperation of exemplary components of another illustrative implementation in accordance with the herein described systems and methods;

FIG. 4 is a block diagram showing an illustrative block representation of an illustrative interactive learning/assessment system in accordance with the herein described systems and methods;

FIG. 5 is a block diagram describing the interaction of various components of an exemplary content production/sharing platform in accordance with the herein described systems and methods;

FIG. 6 is a block diagram describing an exemplary content distribution/sharing scheme in accordance with the herein described systems and methods; and

FIG. 7 is a flow diagram showing illustrative processing performed in producing/sharing content in accordance with the herein described systems and methods.

### DETAILED DESCRIPTION

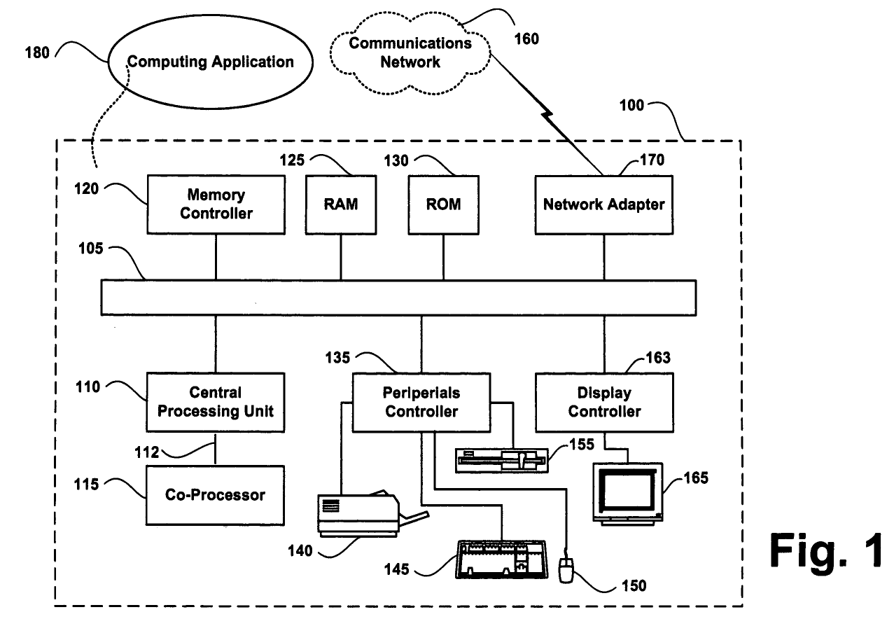

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

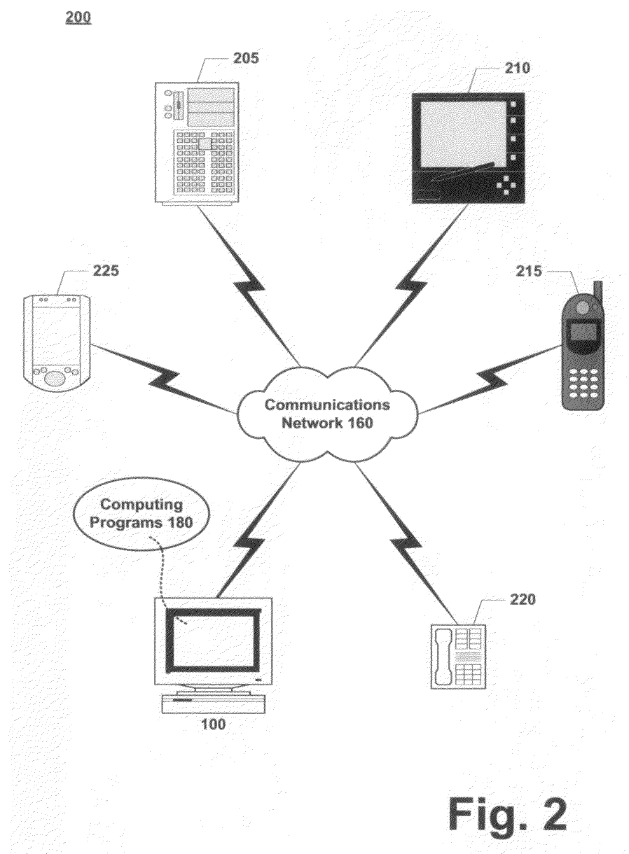

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

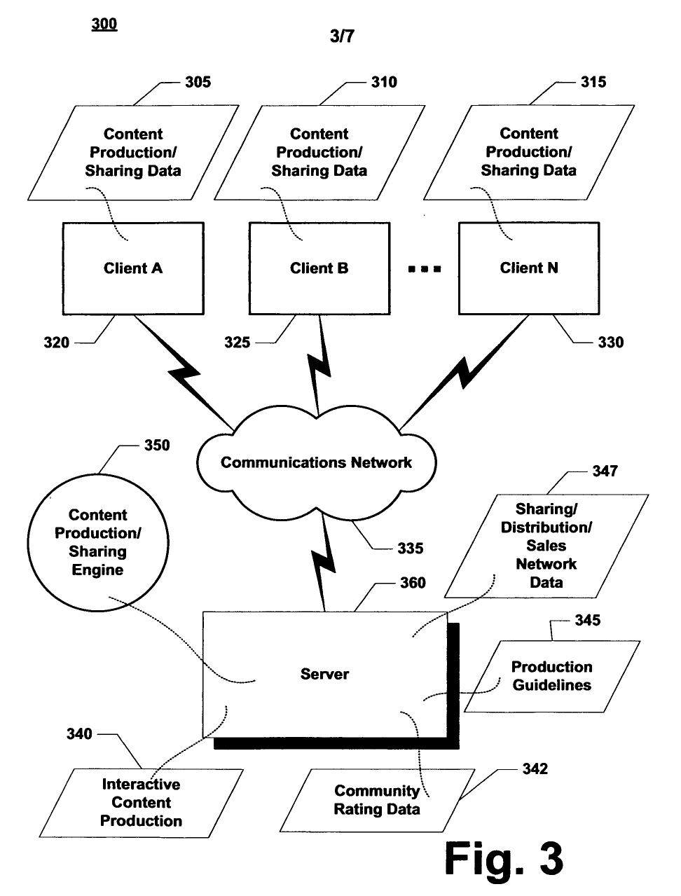

FIG. 3 shows an illustrative implementation of exemplary content production/sharing platform 300. As is shown in FIG. 3, exemplary content production/sharing platform 300 comprises client computing environment 320, client computing environment 325 up to and including client computing environment 330, communications network 335, server computing environment 360, content production/sharing engine 350, interactive content production 340, community rating data 342, production guidelines 345, and sharing/distribution/sales network data 347. Also, as is shown in FIG. 3, content production/sharing platform 300 can comprise a plurality of content production/sharing data (e.g., produced content and/or content portions) 305, 310, and 315 which can be displayed, viewed, stored, electronically transmitted, and printed from client computing environments 320, 325, and 330, respectively.

In an illustrative operation, client computing environments 320, 325, and 330 can communicate and cooperate with server computing environment 360 over communications network 335 to provide requests for and receive content production/sharing data 305, 310, and 315. In the illustrative operation, content production/sharing engine 350 can operate on server computing environment 360 to provide one or more instructions to server computing environment 360 to process requests for content production/sharing data 305, 310, and 315 and to electronically communicate content production/sharing data 305, 310, and 315 to the requesting client computing environment (e.g., client computing environment 320, client computing environment 325, or client computing environment 335). As part of processing requests for content production/sharing data 305, 310, and 315, content production/sharing engine 350 can utilize a plurality of data comprising interactive production content 340, community rating data 342, production guidelines 345, and/or sharing/distribution/sales network data 347. Also, as is shown in FIG. 3, client computing environments 320, 325, and 330 are capable of processing content production/sharing data 305, 310, and 315 for display and interaction to one or more participating users (not shown).

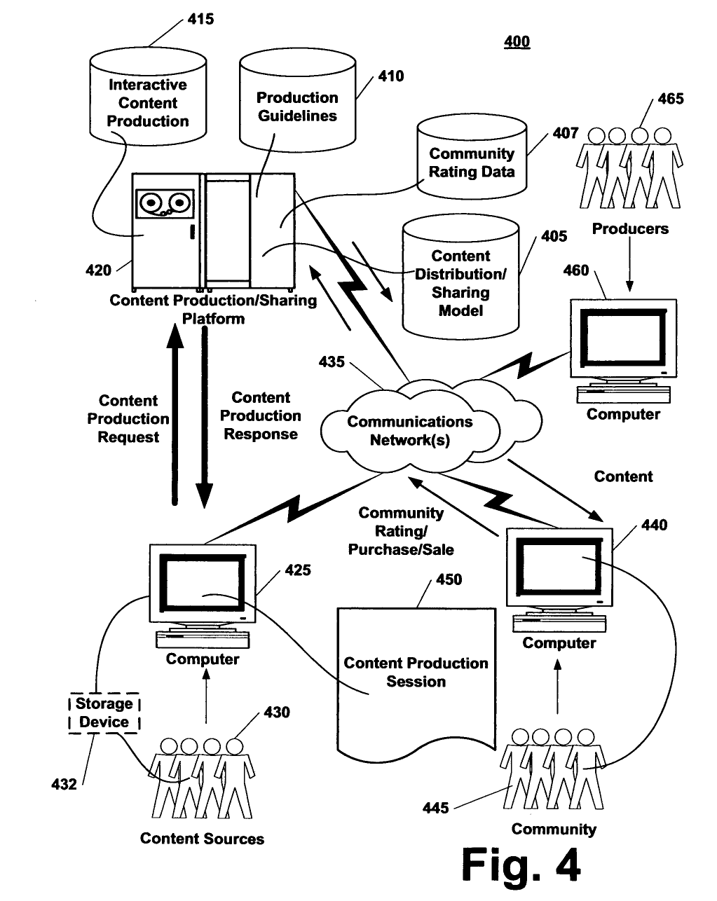

FIG. 4 shows a detailed illustrative implementation of content production/sharing environment 400. As is shown in FIG. 4, exemplary content production/sharing environment 400 comprises content production/sharing platform 420, interactive content production data store 415, production guidelines data store 410, content distribution/sharing model data store 405, and community rating data store 407, user computing environment 425, content sources (e.g., users) 430, community computing environment 440, community 445, producers computing environment 460, and producers 465. Additionally, as is shown in FIG. 4, content production/sharing environment 400 can comprise content production session content (e.g., live and/or stored) 450 which can be displayed, viewed, transmitted and/or printed from content source (e.g., user) computing environment 425, community computing environment 440, and/or producer computing environment 460. Further as is shown, user computing environment 425 can cooperate with a storage device (e.g., memory storage device, mobile phone, MP3 device, MP4 device, video-camera, etc.) to source content for communication and processing with content/production/sharing platform 420.

In an illustrative implementation, content production/sharing platform 420 can be electronically coupled to user computing environment 425, community computing environment 440, and producer computing environment 460 via communications network 435. In the illustrative implementation, communications network can comprise fixed-wire and/or wireless intranets, extranets, and the Internet.

In an illustrative operation, users 430 can interact with content production/sharing interface (not shown) operating on user computing environment 425 to provide requests to initiate a content production/sharing session that are passed across communications network 435 to content production/sharing platform 420. In the illustrative operation, content production/sharing platform 420 can process requests for a content production/sharing session and cooperate with interactive content production data store 415, production guidelines data store 410, content distribution/sharing data store 405, and community rating data store 407 to generate a content production/sharing session (e.g., including interactive produced content) for use by users 430, community 445, and producers 465.

In an illustrative implementation, interactive content production data store 415 can comprise produced content and/or content portions provided by one or more users for purchase and/or resale by community 445 and/or producers 465. Such data can include but is not limited to digital content including but not limited to (live and/or recorded), movies, spoken word, music, digital media works, artwork which can be viewed, purchased, and distributed by community 445, users 430, and/or producers 465. In the illustrative implementation, production guideline data store 410 can comprise data representative of one or more production thresholds which are required to be satisfied before users 430 can seek community 445 assistance and producers 465 guidance (and/or financing) in producing desired content for future distribution. Content distribution/sharing model data store 405 can comprise one or more content distribution/sharing/sales schemes for use by users 430, community 445, and producers 465 when distributing produced content (and/or content portions) amongst users 430, community 445, and producers 465. Community rating data store 407 can comprise data representative of community feedback for produced content (not shown) and/or content desired to be produced (not shown) by users 430.

In the illustrative operation, exemplary content production/sharing environment 400 can provide one or more features to participating users 430, community 445 (e.g., online social networking type community of users—e.g., MYSPACE.COM or YOUTUBE.COM), and producers 465 (e.g., production companies desiring to leverage the resources available in an online social networking type community to produce content) to purchase, sell, and/or produce content. In an illustrative implementation, a community member (who can also be a user) can search the produced content on interactive content production data store 415 for produced content (or content portions) for purchase. In the illustrative implementation, the buyer can consummate the purchase of the desired produced content (or content portions). In the illustrative implementation, the revenue from such transaction can be distributed to the seller of the produced content (or content portions) according to one or more content distribution/sharing models found on content distribution/sharing model data store 405.

In another illustrative implementation, a user (who also can be a community member) can place produced content (or content portions) for sale on exemplary content production/sharing platform 420. In the illustrative implementation, the user can sell the produced content (or content portions) to interested buyers through the consummation of a transaction. The revenue from this transaction can be distributed to the seller of the produced content (or content portions) according to one or more content distribution/sharing models found on content distribution/sharing model data store 405.

In another illustrative implementation, a user (who can also be a community member) can seek the assistance of a producer (who can be a community member) and other community members to produce desired content. In the illustrative operation, the user would provide a container having one or more content components (e.g., content idea, script/score, budget, and/or demo) for critique and review by producers 465 and/or community 445. If the container is well received (e.g., satisfy one or more required production guidelines as found on production guidelines data store 410), the desired content to be produced can be tagged as production worthy. In the illustrative implementation, producers 465 can assist users who have production worthy content to locate production fmancing through one or more content fmancing production schemes (e.g., securitization of content to the community and/or public at large to raise necessary fmancing) and/or to produce the production worthy content.

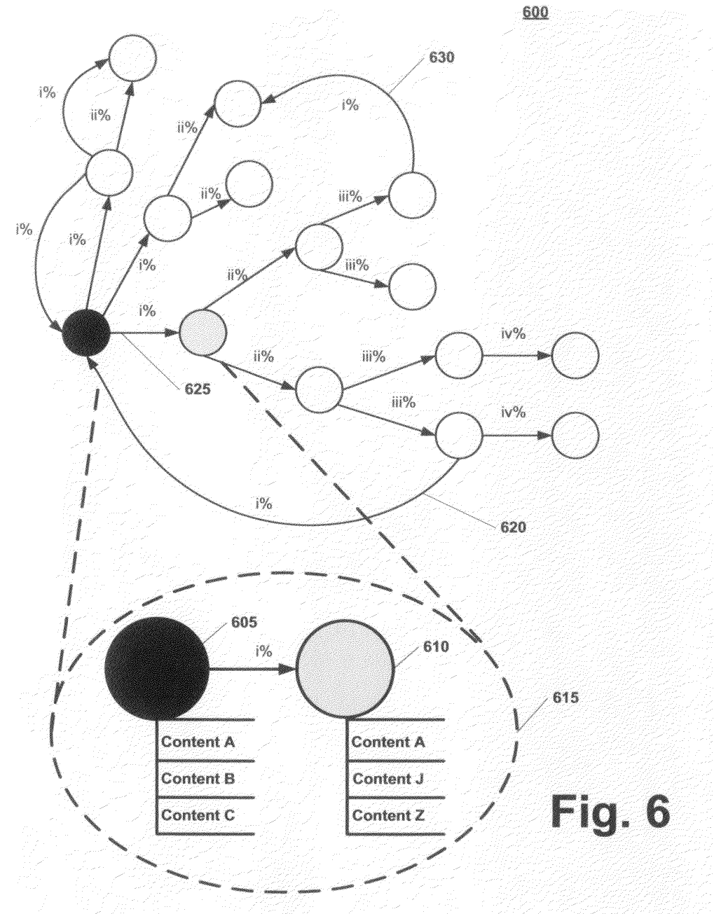

Exemplary features of exemplary content production/sharing environment 400 can comprise: allowing for the sale or licensing of any content to any of the community members (e.g., including users and producers); the content producer (e.g., participating users) is afforded administrative privileges so as to allow direct deals exclusively (e.g., a community member wishing to license the content is required to contact the producer, whether or not the community member is a direct contact of the producer or a contact of another community member); the producer can allow community members to reorganize/redistribute their content (e.g., in this context, the redistribution of content can be exacted through a selected sales/distribution scheme which can comprise commission based (% of sales) and a fixed wholesale price model, i.e., for every sale of the content, the producer makes x % or $x, and the remaining is distributed among the chain of community members that led to the sale as described below and by FIG. 6); the IP associated with the produced content (or content portions) can be transferred to another party or traded (e.g., exchange of assets); content can be organized into various portfolios (e.g., where the categories of organization can be user-defined; the content can also be categorized by channels—a rolling sequence of like genre content); advertisers can be enabled to subsidize the cost of viewing any content by community members; applies various licensing schemes comprising a “right to view” that is transferred to parties licensing (or purchasing) the content (e.g., this right can be controlled by multiple factors comprising timing (one view, a length of time), number of people who can view it (e.g., one person, friends & family network)); providing, illustratively, a rights management technology to allow downloads of content; allow community members to rate original content or the channels any of the distributors create; and allow a producer to create a portfolio to seek financing for their content under production using a selected financing scheme (e.g., public securitization model where community members or the public at large can buy stock into the content to be produced). As part of the financing scheme, investors can also be provided a right to license/redistribute the content.

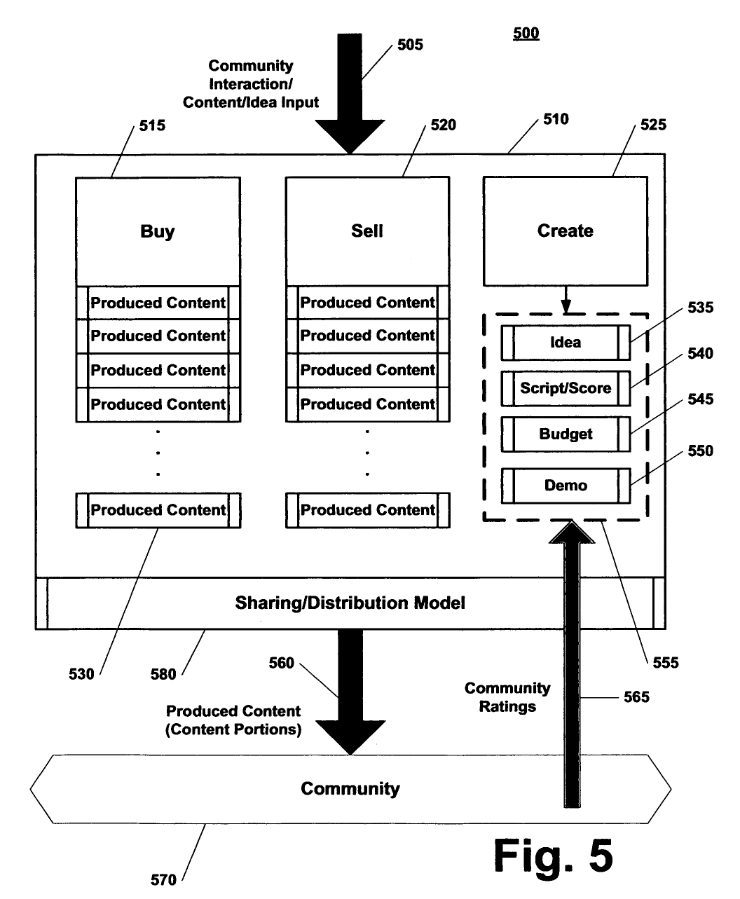

FIG. 5 shows exemplary content production/sharing environment 500. As is shown content production/sharing environment 500 comprises content production/sharing platform 510, sales and distribution model 580, and community 570. Further, as is shown in FIG. 5, content production/sharing platform 510 further comprises “Buy” module 515, “Sell” module 520, “Create” module 525, produced content 530, and proposed content container 555. Proposed content container 555 can comprise one or more content components including but not limited to idea 535, script/score 540, budget 545, and demo 550.

In an illustrative operation, exemplary content production/sharing environment 500 can operate to allow participating users (not shown) upload produced content (as indicated by arrow 505) to exemplary content production/sharing platform 510 for sale by “Sell” module 520. Further, in the illustrative operation, exemplary content production/sharing environment 500 allows participating users (who can be community members) to purchase produced content 530 stored on content production/sharing platform 510 using “Buy” module 515 and receiving produced content 560. Further, exemplary content production/sharing environment 500 allows participating user (who can also be community members) to propose content by generating proposed content container 555 for production using “Create” module 525. In the illustrative operation, “Create” module 525 can employ community ratings 565 as part of processing the components of proposed content container 555 to determine whether the proposed content for production is production worthy. Further, in the illustrative operation, sharing/distribution model 580 can operate to provide one or more revenue sharing streams for purchased and sold produced content (e.g., sharing revenue between a seller and buyer if the buyer resells the purchased produced content to another purchaser).

FIG. 6 shows exemplary content distribution/sharing model 600. As is shown, exemplary content distribution/sharing model 600 comprises a plurality of parties 605 and 6010 interconnected through predefined relationships 620, 625 and 630. In an illustrative implementation, a content production/sharing platform (not shown) can comprise a community of users which are interconnected to each other through pre-defined designations comprising content source and content purchaser. The pre-defined relationships also represent the commission that will be shared between a seller and a subsequent purchaser. In this exemplary distribution/sharing model the percentage commission, as is shown, depends on the degree of separation between the original seller of the produced content and the subsequent purchaser. For example, as is shown in FIG. 6, the original seller will receive i % commission from the sales price from a first degree separated buyer if the buyer resells it to a purchaser that is two degrees separated from the original seller. If the two degree buyer then sells the produced content sourced by the original seller to a subsequent purchaser who is three degrees separated the original seller will receive a ii % commission of the sales price from the two degree buyer who has resold the produced content sourced from the original seller. As such, the exemplary content distribution/sharing model provides an ongoing royalty to the original source of produced content as it is being sold and resold among the various community members (and/or the public at large).

In the illustrative implementation, and as is shown in blown up portion 615 of FIG. 6, community member 605 can act as a content source to community member 610 such that content A is sold from community member 605 to community member 610. As is shown in blown up portion 615, community member 605 can act as a source for Content A. Content A can originally be purchased by community member 610 for a set price X. Community member will receive X for the original sale and a i % commission on all sales made by community member 610 for Content A that community member 610 sells to other community members (not shown) or the public at large. According to exemplary distribution/sharing model 600, the predefined relationships can be established by various factor comprising community member preferences (e.g., community member 605 choose community member 610 to a first degree separation since community member 610 purchases volumes of produced content from community member 605), community member behavior, resale amounts, community member ratings, and content provided for original sale by community members.

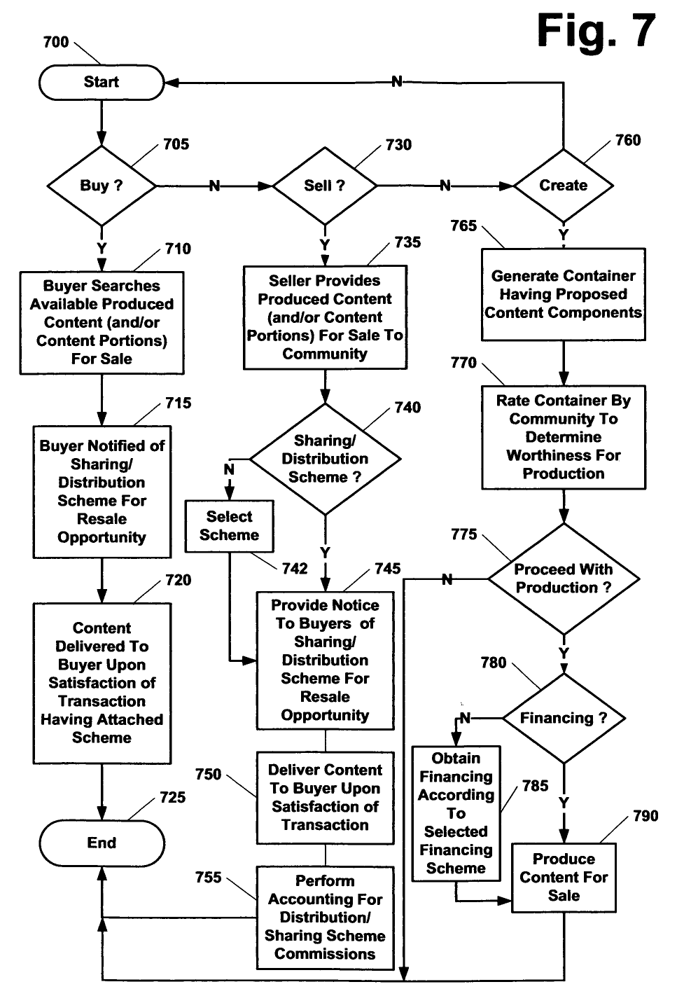

FIG. 7 shows exemplary processing performed when producing and sharing content. As is shown in FIG. 7, processing begins at block 700 and proceeds to block 705 where a check is performed to determine if a content buy operation is being performed. If the check indicates that a buy operation is being performed, processing proceeds to block 710 where a buyer searches available produced content (and/or content portions) for sale. Processing then proceeds to block 715 where the buyer is notified of the sharing/distribution scheme for resale opportunities. The content is then delivered to the buyer upon the satisfaction of the transaction (also having the distribution/sharing scheme attached to the purchased content an/or content portions). Processing then terminates at block 725.

However, if the check at block 705 indicates that a buy operation is not being performed, a check is performed to determine if a sell operation is to be performed. If the check at block 710 indicates that a sell operation is to be performed, processing proceeds to block 735 where the seller provides the produced content (and/or content portions) for sale to the community members. A check is then performed at block 740 to determine if a sharing/distribution scheme has been selected. If the check at block 740 indicates that a sharing/distribution scheme has not been chosen processing proceeds to block 742 where a distribution/sharing scheme is selected. Processing proceeds to block 745 and continues from there. If, however, the check at block 740 indicates that a sharing/distribution scheme has been selected, processing proceeds to block 745 where notice is provided to buyers of the sharing/distribution scheme for resale opportunity. The content is then delivered to buyers upon the satisfaction of a transaction. Form there, processing proceeds to block 755 where an accounting is performed according the selected distribution/sharing scheme to determine which commissions are to be paid. Processing then terminates at block 725.

However, if the check at block 730 indicates that a sell operation is not to be performed, processing proceeds to block 760 where a check is performed to determine if create operation is to be performed. If the check at block 760 indicates that a create operation is not to be performed, processing reverts to block 700 and proceeds from there. However, if the check at block 760 indicates that a create operation is to be performed, processing proceeds to block 765 to generate a container having proposed content components. From there, processing proceeds to block 770 where the container is rated by the community to determine if the proposed content is production worthy. A check is then performed at block 775 to determine if the ratings (along with other production guidelines) are satisfactory to proceed with production.

If the check at block 775 indicates that proposed content is not production worthy, processing terminates at block 725. If, however, the check at block 775 indicates that the proposed content is production worthy, processing proceeds to block 760 where a check is performed to determine if the proposed content requires fmancing. If the check at block 760 indicates that proposed content requires financing, processing proceeds to block 785 where fmancing is obtained according to a selected fmancing scheme (e.g., securitization of the proposed content to community members and/or members of the public at large to raise required funds). Processing then proceeds to block 790 and continues from there. If the check at block 760 indicates that fmancing is not required (e.g., a producer commits to the financing as part of determining production worthiness), processing proceeds to block 790 where the content is produced for sale. Processing then terminates at block 725.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments, including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A system for content production/sharing comprising:
a data store comprising any of content production, production guidelines, community rating data, and distribution/sharing model data;
a content production/sharing engine operable on the data store to provide content production/sharing operations comprising content purchase, content sales, and/or content creation,
wherein one or more participating users can interact with the content production/sharing engine to purchase and/or sell content according to a selected distribution/sharing model,
wherein the one or more participating users can interact with the content production/sharing engine to generate a proposed content container comprising one or more content components for processing according to the production guidelines and rated to generate community rating data to determine production worthiness of the proposed content.

2. The system as recited in claim 1, wherein the production/sharing engine electronically receives production content for processing according to the production guidelines stored on the data store.

3. The system as recited in claim 1, wherein the production/sharing engine cooperates with one or more participating users comprising a rating community to provide content for rating according to one or more selected content rating paradigms.

4. The system as recited in claim 3, wherein the production/sharing engine electronically receives rating data representative of content rating from the rating community for content provide by the production/sharing engine for rating.

5. The system as recited in claim 4, wherein the production/sharing engine processes the received rating data according to the production guidelines to determine content which passes one or more selected rating thresholds as part of a decision to further process content having a rating above the selected one or more rating thresholds according to one or more selected content production/sharing paradigms.

6. The system as recited in claim 2, wherein the production/sharing engine electronically receives production content for processing from one or more cooperating computing environments.

7. The system as recited in claim 6, wherein the one or more cooperating computing environments receives production content from one more cooperating storage devices.

8. The system as recited in claim 1, wherein the production/sharing engine processes requests for the purchase of the one or more content components.

9. The system as recited in claim 8, wherein the production/sharing engine provides the one or more content components responsive to requests for purchase.

10. The system as recited in claim 9, wherein the production/sharing engine processes distribution/sharing model data to generate data representative of how the revenue is to be shared, the revenue resulting from the purchase of the one or more content components.

11. The system as recited in claim 10, wherein the production/sharing engine comprises a computing application.

12. A computer-implemented interactive method for the production and sharing of content comprising:
receiving a request to share production content;
obtaining one or more ratings on the received production content to determine if the received production content is worthy of sharing; and
making available production content that is deemed worthy of sharing.

13. The method as recited in claim 12, further comprising generating a content container for one or more components of received production content, the content container operative to store and delete one or more production content components according to one or more selected content aggregation schemes.

14. The method as recited in claim 13, further comprising providing received production content for rating by one or more participating users.

15. The method as recited in claim 14, further comprising receiving ratings data from one or more participating users representative of the one or more participating users' ratings of provided production content.

16. The method as recited in claim 15, further comprising making available production content if the received rating data for the received production content is above a selected threshold deeming the received production content as worthy of sharing.

17. The method as recited in claim 16, further comprising making available worthy production content for sale.

18. The method as recited in claim 17, further comprising receiving requests for the purchase/investment of available worthy production content.

19. The method as recited in claim 12, further comprising receiving requests for the purchase/investment of production content.

20. The method as recited in claims 18 or 19, further comprising sharing revenue from the sale of production content and/or worthy production content according to a selected revenue sharing distribution model.
